(19) United States
(12) Patent Application Publication
(10) Pub. No.: US 2005/0161954 A1
(43) Pub. Date: Jul. 28, 2005

(54) Hinged door safety device

(76) Inventor: Michael Miskin, Sleepy Hollow, IL (US)

Correspondence Address: FACTOR & LAKE, LTD, 1327 W. WASHINGTON BLVD., SUITE 5G/H, CHICAGO, IL, 60607, US

(21) Appl. No.: 11/017,530

(22) Filed: Dec. 20, 2004

Related U.S. Application Data
(60) Provisional application No. 60/531,306, filed on Dec. 19, 2003.

(51) Int. Cl. E05C 3/02

(52) U.S. Cl. 292/229

(57) ABSTRACT

A safety device for use with a door panel hinged to another door element such as another door or to a door frame or jamb for relative swinging motion of the door panel. The device has a block sized and configured to insert into a triangular space formed between a door panel and another door element to which the door panel is hinged when the door panel is in a non-closed position, but to resist traverse through a through-gap between the door panel and the other door element to which it is hinged. A keeper is connected to the block, the keeper having a first portion thereof being sized to fit through the through-gap, and a second portion adapted to resist traverse through the through-gap when in normal operation of the door after installation of the safety device. A first portion of the keeper is resilient, thus permitting a distance between the second portion of the keeper and the block to be varied without disconnecting the block from the keeper while providing a bias force to urge the block into the triangular space when the door is in a non-closed position. The first portion of the keeper is sized to permit a distance between the block and the second portion of the keeper to be sufficient to permit the block to be completely out of the triangular space while still being connected to the second portion of the keeper.

### CROSS REFERENCE TO RELATED APPLICATIONS

This application claims the benefit of U.S. Ser. No. 60/531,306 filed Dec. 19, 2003.

### TECHNICAL FIELD

This invention relates to a safety device for hinged doors. More specifically, the invention relates to a blocking means that automatically enters into the open gap of a hinged door for preventing injuries to small children by precluding them from being able to close the doors once they are opened.

### BACKGROUND OF THE INVENTION

On many occasions, a child injures itself severely by insertion of its fingers or other body parts into the open gap created on the front face of a bi-fold door or the gap created between a hinged door and the fixed door frame. Occasionally, children may accidentally close a door on the fingers or other body parts of another child while at play. It is also very common among children at play to shut themselves alone inside a room or closet by closing the hinged door. This is frequently an undesirable event.

Others have proposed devices to address the first of the aforementioned problems. For example, in U.S. Pat. No. 5,001,862 a foldable, accordion-like protective member that extends over at least a portion of the height of the front and/or rear face opening of a hinged door is proposed. Also in U.S. Pat. No. 5,092,077 a safety device covering the vertical edge of a hinged door and adjacent jamb on the hinge side is discussed. Both of these devices, by folding and unfolding actions, cover up the gap created by the opening and closing of the hinged door. In U.S. Pat. No. 5,509,235 a mechanism having a spring-loaded stopper connected to a bracket that mounts to the door by hardware or adhesive is proposed. Such devices address only part of the problems commonly associated with hinged doors. Some of these devices are not portable, and are cumbersome to make, transport and install. Also, these devices are not easily relocated from door to door without the risk of defacing the doors from hardware or adhesive marks if they were to be removed.

### SUMMARY OF THE INVENTION

A primary object of the present invention is to provide a portable, inexpensive and effective safety device for hinged doors that can be readily installed to an existing door.

Another object of the present invention is to provide a simple safety device for hinged doors that can address the aforementioned problems commonly associated with hinged doors.

A further object of the present invention is to provide a portable safety device for hinged doors that can be easily and inexpensively manufactured and can be used on a first door and re-used on other doors.

Yet another object of the present invention is to provide an effective safety device for hinged doors that can be attached and moved from door to door without the need for tools, mounting hardware or adhesives.

According to the invention, a safety device for use with a door panel hinged to another door element such as another door or to a door frame or jamb for relative swinging motion of the door panel includes a block sized and configured to insert into a triangular space formed between a door panel and another door element to which the door panel is hinged when the door panel is in a non-closed position, but to resist traverse through a through-gap between the door panel and the other door element to which it is hinged. A keeper connected to the block, the keeper having a first portion thereof being sized to fit through the through-gap, and a second portion adapted to resist traverse through the through-gap when in normal operation of the door after installation of the safety device.

The first portion of the keeper is resilient, thus permitting a distance between the second portion of the keeper and the block to be varied without disconnecting the block from the keeper while providing a bias force to urge the block into the triangular space when the door is in a non-closed position.

According to another aspect of the invention, the first portion of the keeper is sized to permit a distance between the block and the second portion of the keeper to be sufficient to permit the block to be completely out of the triangular space while still being connected to the second portion of the keeper.

According to another aspect of the invention, the second portion of the keeper is in the form of a flexible ligature, such as a string or strap.

According to another aspect of the invention, the ligature of the first and second portion of the keeper has at least two free ends and a means for connecting the free ends of the ligature to form a loop.

According to another aspect of the invention, the ligature is made from an elastic material.

According to another aspect of the invention, the block and the first and second portions of the keeper are integrally molded as a single body from an elastic material.

According to another aspect of the invention, a combined length of the ligatures is sufficient to secure the safety device on a door by the ligatures looping around a hinge of the door.

According to another aspect of the invention, the device is secured in place to the door assembly by a combination of friction and biasing of the block and the keeper to maintain frictional engagement of the block and keeper against door assembly components.

According to another embodiment of the present invention a means of easily grabbing the blocking means via a handle or other means is provided that is part of or connected to the blocking means.

According to another embodiment of the invention a blocking means is provided having a geometry that provides the least amount of wear to the hinged door.

Yet another embodiment of the invention provides that more than one blocking means connected together on opposing sides of the hinged door by the biasing means capable of passing through the gap of the hinged door.

### BRIEF DESCRIPTION OF THE DRAWINGS

FIG. 1 is a perspective view of an embodiment of the invention;

FIG. 2 is a top view of the device of FIG. 1 as used on a bi-fold door;

FIG. 3 is a top view of the device of FIG. 1 as used on a bi-fold door;

FIG. 4 is a perspective view of another embodiment of the invention;

FIG. 5 is a perspective view of yet another embodiment of the invention; and

FIG. 6 is a perspective view of the device of FIG. 1 used on a standard hinged door.

### DETAILED DESCRIPTION OF PREFERRED EMBODIMENTS

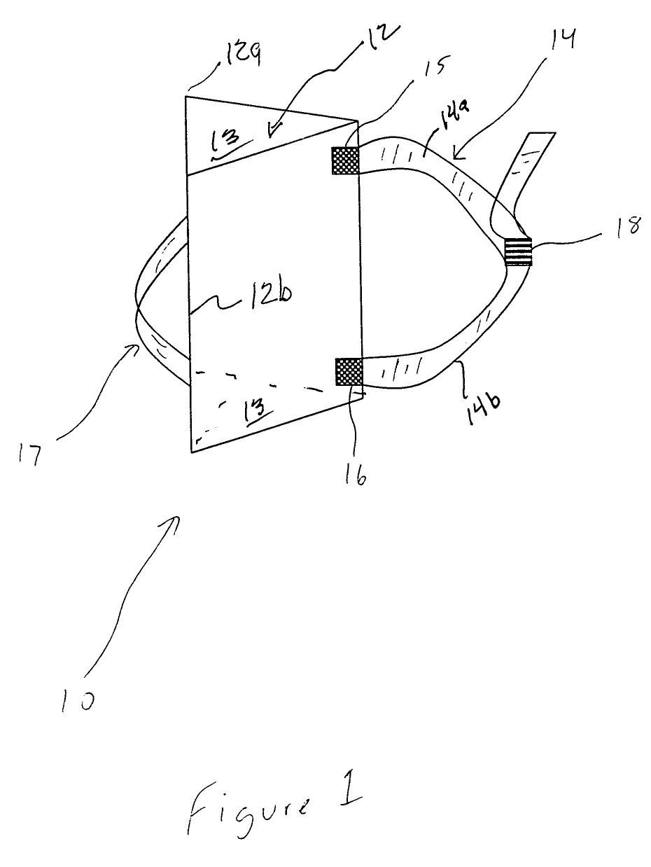

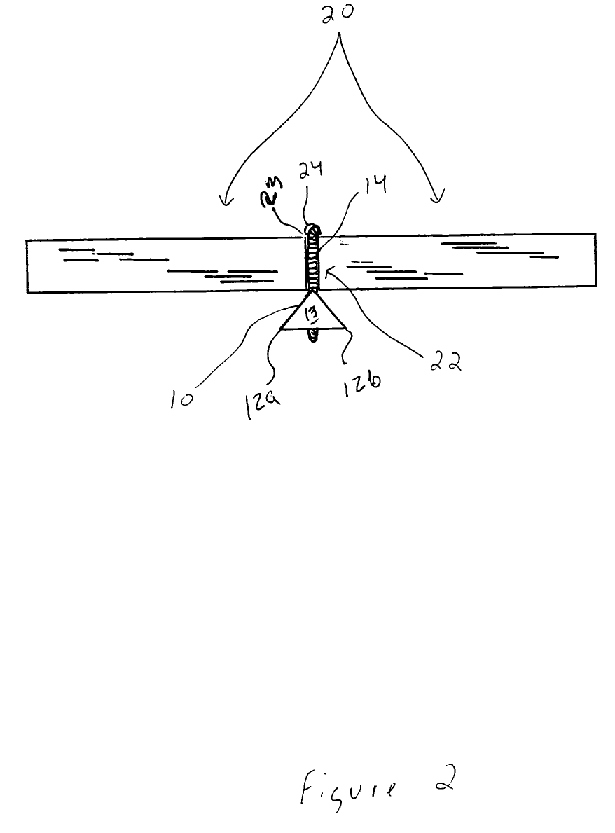

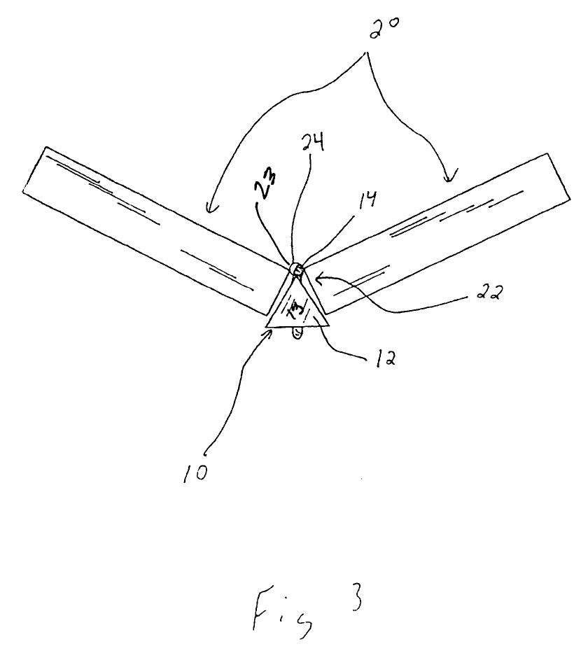

FIG. 1 disclose a safety device 10 for use with a door panel hinged to another door element such as another door or to a door frame or jamb for relative swinging motion of the door panel. FIGS. 2 and 3 disclose the device 10 in use with a bi-folding door where like door panels 20 comprise both elements of the hinged assembly.

FIGS. 1-3 disclose that the safety device 10 includes a block 12 sized and configured to insert into a triangular space 22 formed between the door panels 20 when the door panels are in a non-closed position. A ligature in the form of a resilient strap 14 having two segments 14a, 14b each having free ends secures the block 12 to the door assembly by looping around a hinge 24. A connector 18 of conventional buckle type (although any conventional connector appears to be appropriate e.g. hook and loop (e.g. Velcro®), snap, or the like) secures the free ends of the straps 14a, 14b together to secure the loop. The free ends could also be simply knotted together. Thus the connected strap 14 effectively has two portions, a first portion which can pass through or traverse a through-gap 23 between the doors panels 20 and a second portion which is comprised by the connected free ends of the strap portions 14a, 14b to resist traverse back through the through-gap 23. Hence, the strap 14 comprises a keeper connected to the block 12 having a first portion thereof being sized to fit through the through-gap 23, and a second portion adapted to resist traverse through the through-gap 23 when in normal operation of the door after installation of the safety device 10.

FIGS. 2 and 3 disclose that preferably at least a first portion of the keeper or strap 14 is resilient, thus permitting a distance between the second connected free ends of strap 14 and the block 12 to be varied without disconnecting the block from the keeper while providing a bias force to urge the block 12 into the triangular space 22 when the doors 20 are in a non-closed position. This allows an adult user to pull the block 12 out of the space 22 and to close the door panels 20. The block 12 will be then biased against the door panels near the through-gap 23 ready for the panels to be opened again. When the door panels 20 are again opened, the biased portion of the strap 14 will pull the block 12 back into the space 22. Once in the space 22, the block 12 will prevent closure of the door panels until the block 12 is again withdrawn.

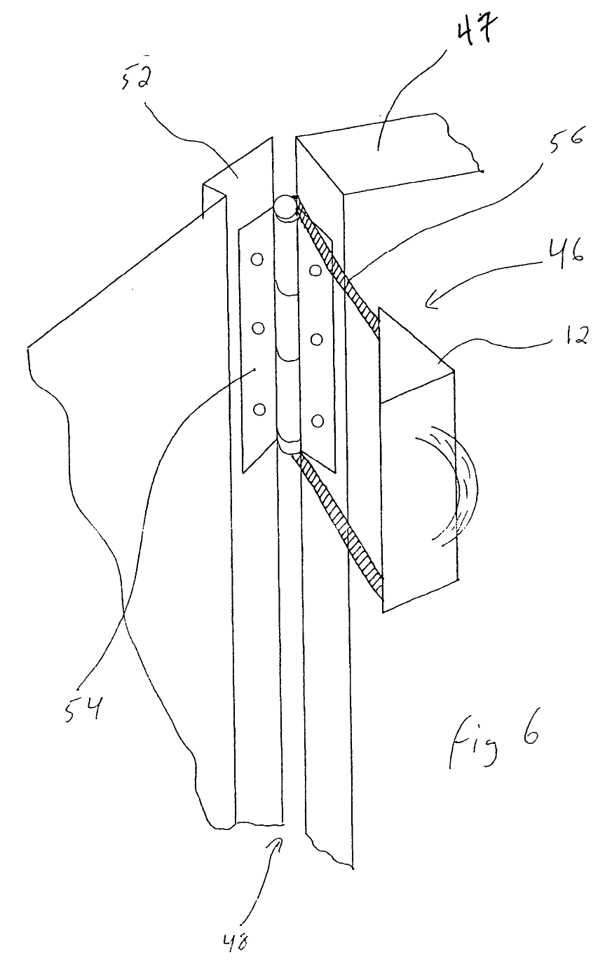

FIG. 6 discloses a safety device 46 very similar to device 10 but installed on a single door panel 47 hinged to a door frame or jamb 52. As described above, a resilient elastic ligature or strap 56 is attached to block 12 and then looped around a hinge 54. The free ends of the strap 56 are connected to form and close a loop. The strap 56 passes through a through-gap 48 and resists retrograde movement back through the gap 48 due to its being connected into a closed loop.

In other embodiments, especially where a ligature is used to secure a block to a hinge, the ligature need only be flexible, not necessarily resilient. It is contemplated that a block could be allowed to enter the space 22 upon gravitational pull when hanging by a ligature looped around a hinge.

The FIGS. 1-6 disclose a block (such as block 12) all in the form of a triangular cylinder or wedge. This is merely a preferred embodiment, conveniently matching the shape of the open space 22. However, the main goal is to provide a block which has a dimension to sufficient to prevent the space 22 from narrowing enough to pinch a finger or to permit the doors to close. Accordingly other geometric shapes could be used without departing from the scope of the invention.

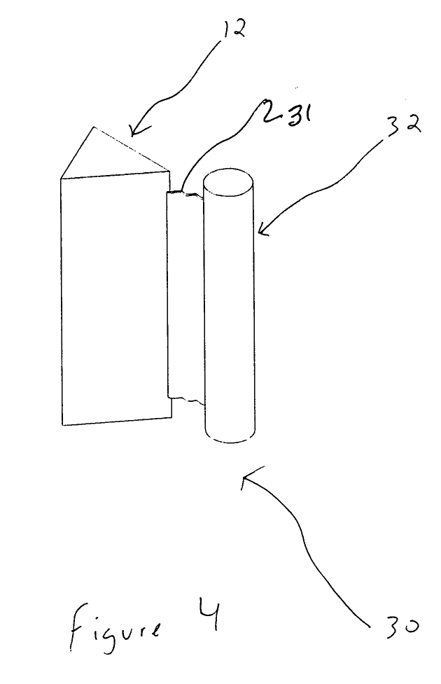

FIG. 4 discloses an embodiment exemplifying another aspect of the invention. In particular a safety device 30 includes a block 12 integrally formed with a keeper comprised of a first portion or web 31 and a second portion or stopper 32. In this embodiment, the stopper 32 is elastic and is sized to be able to pass through the through-gap (such as gap 23 of FIGS. 2 and 3) by being elastically deformed and pushed through the through-gap 23. One through the gap 23, the stopper 32 expands and is resistant to being withdrawn back through the gap 23. The web 31 is also resilient. This permits the automatic entry of the block 12 into the triangular space 22 when the doors 20 are opened. This arrangement also provides that the device 30 is secured in its vertical location by a combination of friction and biasing of the block 12 and the keeper (31, 32).

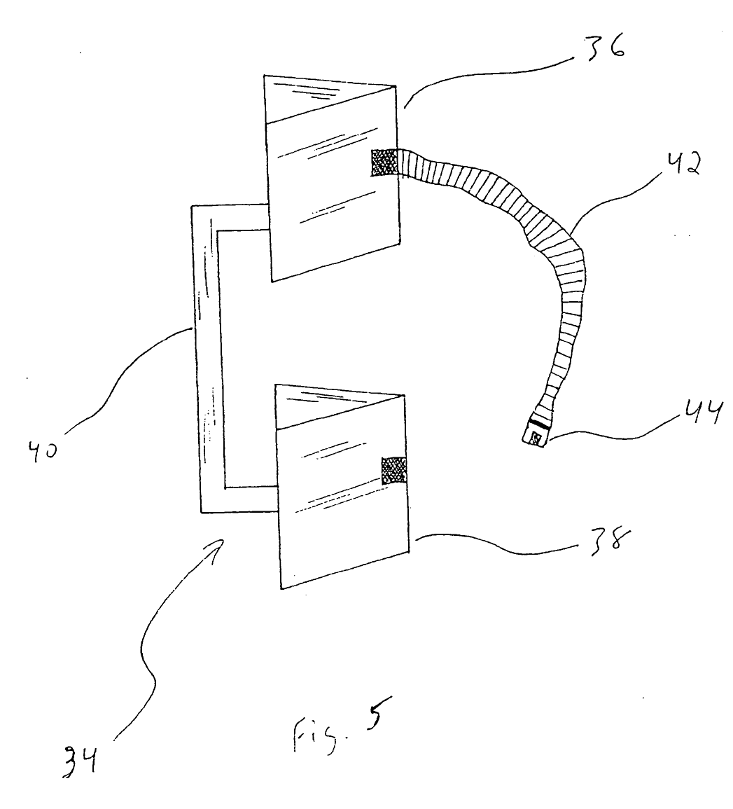

FIG. 5 discloses another exemplary embodiment of the invention. Particularly a safety device 34 includes two blocks 36 and 38 connected by a single resilient ligature or strap 42. This embodiment provides a removable connection with at least one of the blocks 36 or 38 to in order to install the device 34 with the strap around a hinge. Conveniently, a handle 40 connected to both blocks 36,38 permits both blocks 36, 38 to be withdrawn from the triangular opening between the door and another door element to which it is hinged with only one hand and at the same time. Thus the keeper in this embodiment is a resilient strap 42 which is intended to loop around a hinge and connect at its free ends one each to the blocks 36, 38.

The embodiment of FIG. 5 could also be configured such that each block 36, 38 could be provided with a keeper such as the embodiment of FIG. 4 where the keeper has a resilient web and a stopper. Also, more than two blocks could be used as deployed in FIG. 5.

The invention contemplates that the blocks and keepers be connected. Within the scope of the invention there have been disclosed various forms of connections and keepers. The invention should not be limited to the type of connection between the blocks and keepers unless so specified in the claims. All connections between blocks and keepers could be permanent or removable attachments such as mating snap fits, snap, clips, and the like.

In all embodiments disclosed herein, it may be preferable to mount the safety device 10 on an upper hinge of the door so as to be harder to reach by children. Also, it will be appreciated that the wedge shape may be sized so as to fit as disclosed in FIG. 3, such that a child's fingers cannot grip the edges 12a, 12b when the block 12 is in the gap 22. At the same time the distance between surfaces 13 of the top and bottom of the block 12 can be made such that a child's hand cannot easily span the distance. Hence, an adult may use the surfaces 13 to grip the block 12 for removal of the wedge from the gap 22 while the surfaces are unavailing for a grip by a child. It should also be understood that other means such as protrusions, from the block (either formed integrally therewith or attached) may be used to assist an adult in removing the block 12 from the gap 22.

While specific embodiments have been illustrated and described herein, numerous modifications may come to mind without significantly departing from the spirit of the invention, and the scope of protection is only limited by the scope of the accompanying Claims.

1. A safety device for use with a door panel hinged to another door element such as another door or to a door frame or jamb for relative swinging motion of the door panel comprising:
a block sized and configured to insert into a triangular space formed between a door panel and another door element to which the door panel is hinged when the door panel is in a non-closed position, but to resist traverse through a through-gap between the door panel and the other door element to which it is hinged;
a keeper connected to the block, the keeper having a first portion thereof being sized to fit through the through-gap, and a second portion adapted to resist traverse through the through-gap when in normal operation of the door after installation of the safety device.

2. The safety device of claim 1 wherein the first portion of the keeper is resilient, thus permitting a distance between the second portion of the keeper and the block to be varied without disconnecting the block from the keeper while providing a bias force to urge the block into the triangular space when the door is in a non-closed position.

3. The safety device of claim 1 wherein the first portion of the keeper is sized to permit a distance between the block and the second portion of the keeper to be sufficient to permit the block to be completely out of the triangular space while still being connected to the second portion of the keeper.

4. The safety device of claim 1 wherein the second portion of the keeper is in the form of a flexible ligature, such as a string or strap.

5. The safety device of claim 4 wherein the first and second portion of the keeper is in the form of a flexible ligature, such as a string or strap.

6. The safety device of claim 4 wherein the ligature of the second portion of the keeper has at least two free ends and a means for connecting the free ends of the ligature to form a loop.

7. The safety device of claim 5 wherein the ligature of the first and second portion of the keeper has at least two free ends and a means for connecting the free ends of the ligature to form a loop.

8. The safety device of claim 7 wherein the ligature is made from an elastic material.

9. The safety device of claim 1 wherein the block is in the form a triangular wedge.

10. The safety device of claim 1 wherein the block includes a handle portion for use by a consumer to retract the block from the triangular space.

11. The safety device of claim 1 wherein the block and the first and second portions of the keeper are integrally molded as a single body from an elastic material.

12. The safety device of claim 2 wherein the block and the first and second portions of the keeper are integrally molded as a single body from an elastic material.

13. The safety device of claim 9 wherein the block and the first and second portions of the keeper are integrally molded as a single body from an elastic material.

14. The safety device of claim 5 wherein a combined length of the ligatures is sufficient to secure the safety device on a door by the ligatures looping around a hinge of the door panel.

15. The safety device of claim 7 wherein a combined length of the ligatures is sufficient to secure the safety device on a door assembly by the ligatures looping around a hinge of the door panel.

16. The safety device of claim 2 wherein the device is secured in place to the door assembly by a combination of friction and biasing of the block and the keeper to maintain frictional engagement of the block and keeper against door assembly components.

17. A safety device for use with a door panel hinged to another door element such as another door or to a door frame or jamb for relative swinging motion of the door panel comprising:
a first block sized and configured to insert into a triangular space formed between a door panel and another door element to which the door panel is hinged when the door panel is in a non-closed position, but to resist traverse through a through-gap between the door panel and the other door element to which it is hinged;
a second block sized and configured to insert into a triangular space formed between a door panel and another door element to which the door panel is hinged when the door panel is in a non-closed position, but to resist traverse through a through-gap between the door panel and the other door element to which it is hinged;
a keeper connected to the first and second blocks, the keeper having a first portion thereof being sized to fit through the through-gap, and a second portion adapted to resist traverse through the through-gap when in normal operation of the door after installation of the safety device; and,
a handle connecting the first and second blocks.

18. The safety device of claim 17 wherein the first portion of the keeper is resilient, thus permitting a distance between the second portion of the keeper and the block to be varied without disconnecting the block from the keeper while providing a bias force to urge the block into the triangular space when the door is in a non-closed position.

19. The safety device of claim 17 wherein the first and second portion of the keeper is in the form of a flexible ligature, such as a string or strap and the ligature of the first and second portion of the keeper has at least two free ends and a means for connecting the free ends of the ligature to form a loop.

20. The safety device of claim 19 wherein a combined length of the ligatures is sufficient to secure the safety device on a door assembly by the ligatures looping around a hinge of the door panel.
